(19) United States
(12) Patent Application Publication
(10) Pub. No.: US 2025/0321051 A1
(43) Pub. Date: Oct. 16, 2025

(54) METHOD AND DEVICE FOR REDUCING THE WATER CONTENT IN A FIBRE-BASED BLANK

(71) Applicant: ALPLA Werke Alwin Lehner GmbH & Co. KG, Hard (AT)

(72) Inventors: Christian PREISS, Feldkirch (AT); Florian MÜLLER, Hard (AT); Anupam AKOLKAR, Dornbirn (AT); Shaikh WASEEM, Dornbirn (AT); Christian CARLSEN, Sorø (DK); Magnus ANDERSEN, Frederiksberg (DK)

(73) Assignee: ALPLA Werke Alwin Lehner GmbH & Co. KG, Hard (AT)

(21) Appl. No.: 18/870,143

(22) PCT Filed: Jun. 2, 2023
(86) PCT No.: PCT/EP2023/064815

§ 371 Date: Nov. 27, 2024

(30) Foreign Application Priority Data
Jun. 3, 2022 (CH) 000680/2022

(51) Int. Cl. F26B 3/347; D21J 3/10; F26B 11/04

(52) U.S. Cl. CPC F26B 3/347; D21J 3/10; F26B 11/0495

(57) ABSTRACT

A method and device for reducing the water content in a fiber-based blank. The method comprises the steps of providing a wet fiber-based blank, subjecting the wet fiber-based blank to microwaves. The fiber-based blank is provided in a microwave-permeable press mold.

The present invention relates to a method and to a device for reducing the water content in a fiber-based blank, in particular a container, or in a fiber-based closure element for a container according to the preamble of the independent claims.

A fiber-based blank in the form of a container was disclosed in WO 2012/139590 A1. To produce this container, so-called pulp is injected into an upside-down mold and pressed against a corresponding wall in this mold using a flexible balloon and compressed accordingly. The pulp is compressed and heated to a temperature of around 180° C. in order to dry the container. It is also known to produce closure elements for containers from pulp.

The pulp is a mixture of fibers and water, in particular natural fibers, such as hemp fibers, cellulose fibers or flax fibers or a mixture thereof. Optionally, the pulp has additives that, for example, improve the curing of the compressed pulp or have an influence on the later appearance or generally change the properties of the pulp or the later container.

The aforementioned method is time-consuming and energy-intensive. It has therefore already been proposed to improve it. WO 2018/020219 A1 introduced a further method for drying wet, fiber-based blanks. In this case too, the blanks are containers. Here, the wet pulp is also pressed together with a flexible balloon inside the casting mold. The pre-processed container is then demolded together with the balloon inside and placed on a conveyor belt. The balloon is removed from the cold-formed container. The container is then exposed to microwaves to dry it. The blank is very sensitive to the application of force before drying and must be handled very carefully. During the drying process, the container may become deformed, for example due to uneven drying or a non-uniform layer thickness, or it may be damaged by external influences.

It is the object of the invention to remedy at least one of the disadvantages of the prior art. In particular, a method and a device are to be provided which make it possible to dry wet fiber-based blanks, in particular containers, such as bottles, cups, bowls or dishes or wet fiber-based closure elements, with low energy expenditure, while ensuring that they remain dimensionally stable.

This object is achieved by the methods and devices defined in the independent claims. Further embodiments result from the dependent claims.

A method according to the invention for reducing the water content in a fiber-based blank, in particular in a fiber-based container or closure element, comprises the steps of:
providing a wet fiber-based blank,
exposing the wet fiber-based blank to microwaves.

The fiber-based blank is provided in a microwave-permeable press mold.

By providing the fiber-based blank in a microwave-permeable press mold, the wet fiber-based blank can remain within the mold during the drying process, i.e. during exposure to microwaves. The container is thus protected against external influences and damage or deformation is prevented. By providing the wet fiber-based blank within the microwave-permeable press mold, it can also be ensured that said blank is accessible to the microwaves from all sides and drying can therefore be carried out from all sides. After this drying step, the wet fiber-based blank has a water content of approximately 5% to 12%.

In the present method, the wet fiber-based blanks are typically shaped as already known in the prior art. In other words, pulp is introduced into a porous casting mold or into a solid casting mold having water-draining channels, the inlets of which are covered with screens or the openings of which are small enough that the fibers of the pulp cannot penetrate, and the fibers of the pulp are applied to the inner wall of the casting mold so as to form a wall of a container. Once the wall is sufficiently thick, the swelling of the pulp stops. The semi-finished product now present, i.e., the wet fiber-based blank, is removed from the casting mold and introduced into the microwave-permeable press mold and thus provided in the press mold. At this point, the wet fiber-based blank has a water content of approximately 75%.

The wet fiber-based blank is removed from the casting mold using a suitable transfer device. Subsequently, the wet fiber-based blank is inserted into the opened press mold. The press mold is preferably formed in two parts. In this case, removal and insertion may require blowing out and/or suction by means of negative or positive pressure. It is also possible to use purely mechanical grippers for this transfer.

Typically, the press mold can have an inner wall that is designed with a higher surface quality compared to the inner wall of the casting mold.

Preferably, after the fiber-based blank has been provided, an expandable tool is introduced into the fiber-based blank. By expanding the expandable tool, the water content of the fiber-based blank can be reduced in a first step. At this point, the wet fiber-based blank has a water content of approximately 50%-60%.

At the same time, a surface with improved properties can be created on the wet fiber-based blank, since, as already explained, the press mold can be designed with a higher quality compared to the casting mold.

It can be provided that the expandable tool remains in the expanded state during exposure to microwaves.

Pressure on the wall of the wet fiber-based blank can be maintained. In addition, as the expandable tool remains inside the wet fiber-based blank, it is supported from the inside and unwanted deformation is prevented. This also improves the surface quality of the blank.

The fiber-based blank can be introduced into a microwave-reflecting microwave chamber before exposure to microwaves, in particular together with the press mold.

This can increase the effect of the microwaves. Microwaves that are not directly absorbed by the wet fiber-based blank are typically reflected by the inner wall of the microwave chamber, thereby increasing the probability that these microwaves will still hit the blank to be dried.

It is generally known that excitation with microwaves can cause molecules to vibrate and that this vibration generates heat. Water, for example, has a natural frequency of 2.45 GHz. The microwaves are therefore preferably generated at this frequency. In order to remove the water or residual moisture from the wet fiber-based blank, the water is preferably heated until it evaporates and diffuses out of the wet blank.

In order to accelerate the drying process, the press mold and/or the microwave chamber may be preheated to a temperature higher than 60° C. but preferably lower than 160° C.

This also prevents the moisture that escapes from the wet fiber-based blank from condensing again in the immediate vicinity of the blank and precipitating as droplets.

Heating can be carried out, for example, using conventional resistance heaters. Additionally or alternatively, it is conceivable to blow in an appropriately heated fluid, for example air, such that the respective elements reach the desired temperature.

An additional or alternative way to preheat the press mold could, for example, be through deliberate, partial absorption of the microwave radiation in the press mold itself in the order of a maximum of 5% of the microwave radiation, or through the release of energy to the press mold from the vapor generated during drying.

It may be possible to discharge the moisture by means of a forced air flow. The moisture can be water vapor or water in its liquid form.

Forced discharge can keep the moisture inside the device at a low level and prevent condensation of the moisture or reheating of the moisture, for example of water droplets by microwave radiation.

In order to improve the drying and/or evaporation of moisture from the wet fiber-based blank, provision can also be made to rotate it during exposure to microwaves.

This makes the energy input into the wet fiber-based blank more uniform and overheating of individual locations of the blank can be avoided.

Provision can be made to expose multiple blanks to microwaves at the same time. For this purpose, provision can be made for multiple blanks, in particular multiple press molds with one blank each, to be introduced into the microwave chamber at the same time. This reduces the cycle time and enables more efficient use of the microwaves.

The blanks can each be rotated around their own axis and/or around a common axis. This enables more efficient use of the microwaves and allows a more uniform energy input into the blanks.

Additionally or alternatively, it would also be conceivable to provide one or more press molds that can accommodate multiple blanks at the same time. This simplifies the device because each blank does not have to be manipulated individually when it is in a multiple press mold.

It was found that multiple individual press molds, including blanks, can be arranged spatially in relation to one another in any way in the microwave chamber. The arrangement has no influence on the uniformity of the energy input.

Additionally or alternatively, provision may be made for a rotating element, a so-called stirrer, to be provided, in particular within the microwave chamber or at the transition of a waveguide to the microwave chamber, and to swirl the microwaves with this element. A stirrer can be used to disrupt the static propagation of the microwaves within the drying chamber, i.e. the microwave chamber, and to minimize regions of high microwave intensity.

Such an arrangement also has a positive effect in terms of a uniform energy input.

Another way of improving quality can be achieved by applying the microwaves in a pulsed manner depending on the water content of the wet fiber-based blank. The pulsing can reduce the power. Typically, towards the end of the drying process, the water content in the wet fiber-based blank is lower and an excessive level of energy can cause the blank to overheat at certain locations. This can be prevented by reducing the power.

The microwave-permeable press mold can be made of a material selected from the list of materials comprising PEI, PI, PE, POM, PEEK, wood, PTFE, ceramic, glass and PP. The press mold can be porous or solid with water-discharging channels or made of a fine-mesh material.

A further aspect relates to a device for reducing the water content in a fiber-based blank, in particular for reducing the water content in a fiber-based blank according to a method as described herein. The device has a microwave chamber for introducing a wet fiber-based container and at least one device for generating microwaves. The device also has an apparatus for supplying and discharging media from the microwave chamber. In particular, this concerns the supply and discharge of compressed air and moisture.

By means of such supply apparatuses and discharge apparatuses, it is possible to generate, within the microwave chamber, a specific air flow with which moisture, which is generated by exposure to microwaves, can be discharged.

The device for generating microwaves can be connected to the microwave chamber by means of a waveguide.

This connection allows the device for generating microwaves to be arranged at a spatial distance from the microwave chamber and the microwave radiation generated by this device to be introduced into the microwave chamber in a targeted manner.

The waveguide preferably has a rectangular cross-section, with its longer side typically aligned in the direction of a longitudinal axis of the microwave chamber. The longitudinal axis of the microwave chamber corresponds substantially to the longitudinal axis of the fiber-based blank or container. This is determined by a connection between a floor of the blank and a casting opening of the blank or the container.

Provision may be made for a stirrer to be provided within the microwave chamber, in particular at the transition between the waveguide and the microwave chamber, and for this stirrer to be used to swirl the microwaves.

Additionally or alternatively, openings may be provided along the waveguide which are connected to the microwave chamber and through which the microwaves can propagate into the microwave chamber. This enables the entire unit to have a reduced size.

The device may have a cover for closing the microwave chamber. In this case, an exhaust air opening can be arranged in the cover. This opening thus corresponds to an apparatus for supplying and discharging a medium from the microwave chamber, in particular compressed air and moisture.

A cover allows the microwave chamber to be easily closed and the exhaust air opening to be precisely aligned, such that a targeted air flow can be generated within the device, i.e. within the microwave chamber.

Provision may be made for multiple exhaust air openings to be provided. This firstly increases the capacity and secondly allows multiple flows to be provided.

Additionally or alternatively, the microwave chamber may be divided, so that the microwave chamber consists of two identical housing parts or of housing parts of different sizes and shapes.

The microwave chamber may additionally or alternatively have a floor. A plurality of openings is arranged in the floor to allow air to enter the microwave chamber. These openings thus correspond to an apparatus for supplying and discharging a medium from the microwave chamber, in particular compressed air and moisture.

It can be provided that the device for reducing the water content in a fiber-based container has multiple devices for generating microwaves. Each of the plurality of devices for generating microwaves may be connected to the microwave chamber by a waveguide.

The individual devices for generating microwaves can thus introduce their generated microwave radiation into the microwave chamber at different locations. At the same time, each of the devices can also be controlled separately and can emit microwave radiation with a different power. The drying of the blank can be carried out in a correspondingly targeted manner, whereby it can be subjected to different power levels at different locations if necessary, so that the drying process is uniform overall. “Uniform” in this case means that the wet fiber-based container reaches a predefined water content, which is achieved simultaneously throughout the entire container.

For this purpose, it can be provided that the waveguides are arranged at different angles, and/or along the longitudinal axis at different heights and/or, in relation to the longitudinal axis, with different orientations of the longer side of the respective rectangular cross-section of the waveguide.

Preferably, the device has a holding device for a microwave-permeable press mold. The microwave-permeable press mold can thus be arranged within the device, in particular within the microwave chamber.

Provision can be made to expose multiple blanks to microwaves at the same time. For this purpose, it can be provided that the device has multiple holding devices in order to hold multiple press molds in the microwave chamber at the same time. This reduces the cycle time and enables more efficient use of the microwaves.

The holding devices can each be designed to rotate around their own axis and/or around a common axis. This enables more efficient use of the microwaves and allows a more uniform energy input into the blanks.

Alternatively, it would also be conceivable to provide a holding device that can hold multiple press molds at the same time or can hold a multiple press mold. This simplifies the device because each press mold does not have to be manipulated individually when it is in the microwave chamber.

A blank can be designed as a container, in particular as a bottle, bowl, cup, (coffee) capsule, tray or can. Furthermore, it is possible to produce closures for containers using the method according to the invention.

The method for reducing the water content in a wet fiber-based blank and a corresponding device are explained with the aid of schematic figures. In the figures:

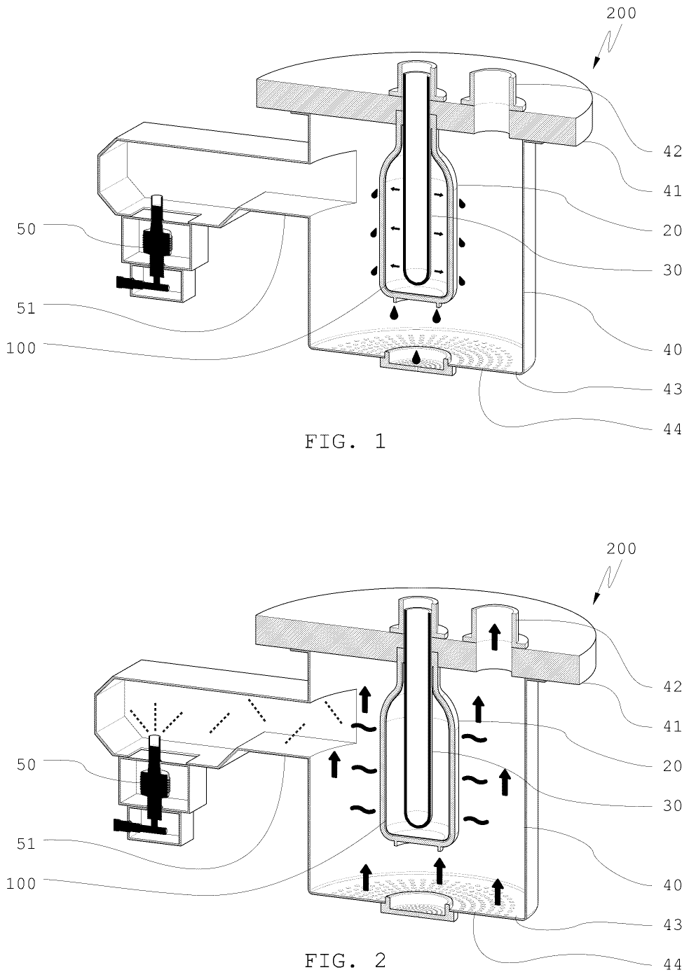

FIG. 1: shows a device before exposure to microwaves;

FIG. 2: shows the device according to FIG. 1 during exposure to microwaves;

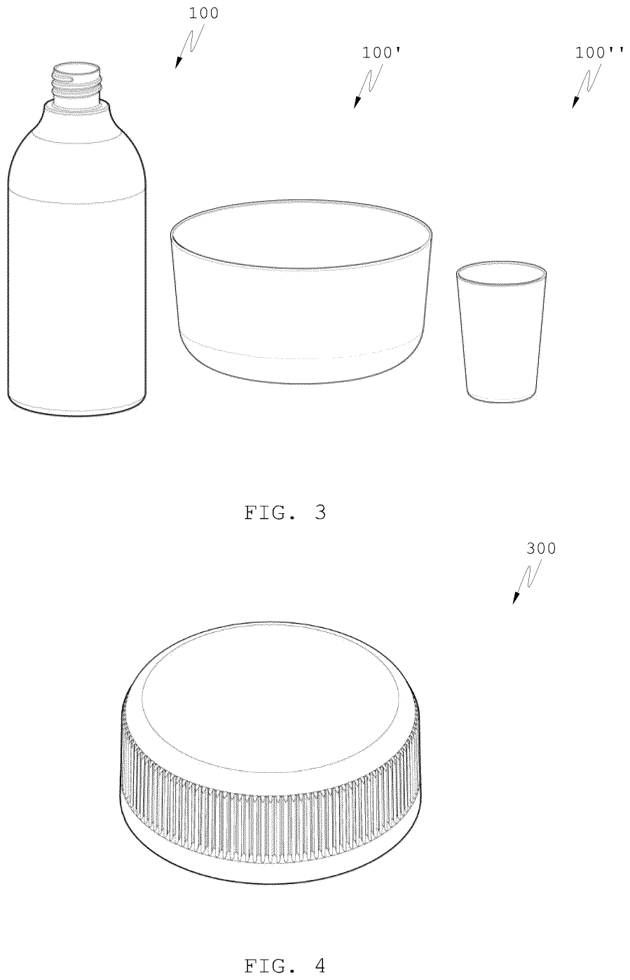

FIG. 3: shows, by way of example, further typical fiber-based containers which can be produced by means of the method according to the invention;

FIG. 4: shows an example of a typical fiber-based closure that can be produced by means of the method according to the invention.

FIG. 1 shows a device 200 for reducing the water content in a fiber-based blank before exposure to microwaves. The fiber-based blank is in the present case a container 100 in the form of a bottle.

The device 200 has a microwave chamber 40 which is closed with a cover 41. In the cover 41 there is an exhaust air opening 42 through which compressed air and/or moisture, such as water or water vapor, can be discharged. The microwave chamber 40 also has a floor 43. A plurality of openings 44 are arranged in the floor, through which openings supply air can be introduced into the microwave chamber 40. The device 200 also has a device 50 for generating microwaves. In the present case, this is designed as a magnetron. The device 50 for generating microwaves is connected to the microwave chamber 40 by means of a waveguide 51. The waveguide 51 is rectangular.

In the device 200, a press mold 20 is arranged within the microwave chamber 40. A wet fiber-based container 100 is arranged within the press mold 20. Said fiber-based container 100 was removed from a casting mold before being introduced into the press mold 20 and at this point in time has a water content of approximately 75%. After the wet fiber-based container 100 was introduced into the press mold 20, an expandable tool 30 was inserted into the interior of the wet fiber-based container 100. By expanding the expandable tool 30, the wall of the container 100 is pressed onto the inner wall of the press mold 20 and the water or moisture in the wet fiber-based container 100 is partially pressed out of it. For this purpose, the press mold 20 is designed to be permeable to water. Water permeability can be achieved with a porosity; alternatively, individual channels or openings can be provided in the press mold. The water can thus be drained through gaps or openings at the parting point of the press mold. The escaping water, or rather the escaping moisture, is represented in a stylized manner by water droplets in the illustration according to FIG. 1. These water droplets can drip onto the floor 43 of the microwave chamber and be discharged through the openings 44. After this step, the fiber-based container 100 has a water content of approximately 50%.

FIG. 2 shows the device according to FIG. 1 during the exposure of the wet fiber-based container 100 to microwaves. FIG. 2 shows the actual drying process. In the device 50 for generating microwaves, microwaves are generated accordingly, which are introduced into the microwave chamber 40 through the waveguide 51. The microwaves heat up the moisture in the fiber-based container 100, in other words, the molecules start to vibrate. The moisture begins to evaporate and exits the container 100 through the microwave-permeable press mold 20. In FIG. 2, the expandable tool 30 is shown in the non-expanded state, but it is possible for the expandable tool 30 to also remain expanded during the process shown here. The moisture, illustrated here in stylized form by wavy lines, enters the microwave chamber 40. To prevent this moisture from precipitating in the microwave chamber 40, air is blown in through the openings 44 in the floor 43 of the microwave chamber 40. This blown-in air flows out of the microwave chamber 40 through the exhaust air opening 42. This creates inside the microwave chamber 40 a flow through which the moisture can be discharged from the microwave chamber 40.

In the present case, a holding device for the microwave-permeable press mold 20 is designed as an integral part of the cover 41. However, it is also conceivable that, for example, the device 200 is formed in two parts, i.e. consists of two halves and, if necessary, of a separate floor. For example, the press mold 20 can be held and pressed together by corresponding elements on the respective halves of the device 200.

FIG. 3 shows examples of other typical fiber-based containers that can be produced using the method described herein. For instance, a container 100 is visible which corresponds to the container 100 from the description of FIGS. 1 and 2. This container 100 is also in the shape of a bottle and also has a thread on the bottle neck. The container 100′ is in the shape of a bowl; the container 100″ is in the shape of a cup.

FIG. 4 shows an example of a typical fiber-based closure 300 that can be produced using the method described herein.

1. A method for reducing the water content in a fiber-based blank, in particular in a container (100, 100′, 100″) or a fiber-based closure element (300) for a container (100), comprising the steps of
providing a wet fiber-based blank,
exposing the wet fiber-based blank to microwaves,
wherein the wet fiber-based blank is provided in a microwave-permeable press mold (20).

2. The method according to claim 1, wherein after the fiber-based blank has been provided, an expandable tool (30) is introduced into the fiber-based blank and the water content of the fiber-based blank is reduced by expansion.

3. The method according to claim 1, wherein an expandable tool (30) is expanded to an expanded state within the fiber-based blank and remains in the expanded state during exposure to microwaves.

4. The method according to claim 1, wherein the fiber-based blank is introduced into a microwave-reflecting microwave chamber (40) before being exposed to microwaves.

5. The method according to claim 1, wherein the press mold (20) and/or the microwave chamber (40) is preheated to a temperature which is higher than 60° C. and lower than 160° C.

6. The method according to claim 1, wherein moisture, in particular water vapor, is discharged by means of a forced air flow.

7. The method according to claim 1, wherein the fiber-based blank is rotated during exposure to microwaves.

8. The method according to claim 1, wherein the microwaves are applied in a pulsed manner depending on the water content of the fiber-based blank.

9. The method according to claim 1, wherein the microwaves, in particular within the microwave chamber (40), are swirled with a stirrer.

10. The method according to claim 1, wherein the microwave-permeable press mold (20) is made of a material from the list comprising: PEI, PI, PE, POM, PEEK, wood, PTFE, ceramic, glass, PP.

11. A device (200) for reducing the water content in a fiber-based blank, in particular according to a method according to claim 1, wherein the device has a microwave chamber (40) for introducing a wet fiber-based blank and at least one device (50) for generating microwaves, wherein the device (200) has an apparatus for supplying and discharging media from the microwave chamber, in particular for supplying and discharging compressed air and moisture.

12. The device (200) according to claim 11, wherein the at least one device (50) for generating microwaves is connected to the microwave chamber by means of a waveguide (51).

13. The device (200) according to claim 11, wherein the device (200) has a cover (41) for closing the microwave chamber (40), wherein an exhaust air opening (42) is arranged in the cover (41).

14. The device (200) according to claim 11, wherein the microwave chamber (40) has a floor (43), wherein the floor (43) has a plurality of openings (44) allowing air to enter the microwave chamber (40).

15. The device (200) according to claim 11, wherein the device (200) has a plurality of devices (50) for generating microwaves, wherein each of the plurality of devices (50) for generating microwaves is connected to the microwave chamber (40) by a waveguide (51).

16. The device (200) according to claim 15, wherein the waveguides (51) are connected to the microwave chamber (40) at different angles.

17. The device (200) according to claim 11, wherein the device has a holding device for a microwave-permeable press mold (20).

18. The device (200) according to claim 17, wherein the microwave-permeable press mold (20) is made of a material from the list comprising: PEI, PI, PE, POM, PEEK, wood, PTFE, ceramic, glass, PP.
